(19) United States
(12) Patent Application Publication
(10) Pub. No.: US 2023/0105797 A1
(43) Pub. Date: Apr. 6, 2023

(54) Method for Operating an Attachment Arranged on a Pick-up Apparatus of a Self-Propelled Combine Harvester

(71) Applicant: CLAAS Selbstfahrende Erntemaschinen GmbH, Harsewinkel (DE)

(72) Inventors: Christian Füchtling, Rinkerode (DE); Andreas Wielenberg, Herford (DE); Udo Beschorn, Harsewinkel (DE)

(21) Appl. No.: 17/960,217

(22) Filed: Oct. 5, 2022

(30) Foreign Application Priority Data
Oct. 5, 2021 (DE) 102021125815.4

(51) Int. Cl. A01D 41/14; A01B 63/00

(52) U.S. Cl. CPC A01D 41/141; A01D 41/145; A01B 63/004

(57) ABSTRACT

The present invention relates to a method for operating an attachment arranged on a pick-up apparatus of a self-propelled combine harvester, wherein the attachment comprises a central portion and two side portions which are each connected to the central portion by a frame joint so as to be pivotable about a pivot axis oriented in the direction of travel, wherein the respective side portion is pivotable about the pivot axis transversely to the direction of travel relative to the central portion by means of an actuator that is activated by a control apparatus, wherein a vertical distance of the attachment from the ground is adaptively set by at least one hydraulic cylinder on the pick-up apparatus, wherein, for the ground guidance of the attachment, the positioning of the side portions relative to the central portion is controlled or regulated independently of vertical and transverse guidance, activated by the combine harvester, of the attachment.

### CROSS-REFERENCE TO RELATED APPLICATIONS

This application claims priority under 35 USC 119 to German Application No. DE 10 2021 125 815.4, having a filing date of Oct. 5, 2021, the disclosure of which is incorporated herein by reference in its entirety.

### BACKGROUND

A method for operating an attachment arranged on a pick-up apparatus of a self-propelled combine harvester is known from WO 2020/185873 A1.

### SUMMARY

The present invention relates to a method for operating an attachment arranged on a pick-up apparatus of a self-propelled combine harvester. The present invention also relates to a self-propelled combine harvester for carrying out such a method.

An attachment which comprises a central portion and two side portions which are each connected to the central portion by a frame joint so as to be pivotable about a pivot axis oriented in the direction of travel of the combine harvester, wherein the respective side portion is pivotable about the pivot axis transversely to the direction of travel relative to the central portion by means of an actuator that is activated by a control apparatus, is guided in terms of height, i.e. the distance from the ground, and in the transverse direction, i.e. the position of the attachment transversely to the direction of travel. Thus, the side portions are supported by position-controlled support wheels which are arranged on the outsides of the side portions in the rear region thereof, while the side positions can move freely about the pivot axis relative to the central portion. The central portion is set in terms of height by means of hydraulic cylinders arranged on the pick-up apparatus. For the transverse guidance of the attachment, provision is made for the central segment to be pivoted about a pendulum axis relative to the pick-up apparatus.

Proceeding from the abovementioned prior art, the invention is based on the object of developing a method for operating an attachment arranged on a pick-up apparatus of a self-propelled combine harvester of the type mentioned at the beginning, and a self-propelled combine harvester, which is characterized by better tracking of the side portions of the attachment upon adaptation to a changed ground contour.

A method for operating an attachment arranged on a pick-up apparatus of a self-propelled combine harvester is proposed, wherein the attachment comprises a central portion and two side portions which are each connected to the central portion by a frame joint so as to be pivotable about a pivot axis oriented in the direction of travel, wherein the respective side portion is pivotable about the pivot axis transversely to the direction of travel relative to the central portion by means of an actuator that is activated by a control apparatus, wherein a vertical distance of the attachment from the ground is adaptively set by at least one hydraulic cylinder on the pick-up apparatus. According to the invention, for the ground guidance of the attachment, the positioning of the side portions relative to the central portion is controlled or regulated independently of vertical and transverse guidance, activated by the combine harvester, of the attachment.

The basic consideration that the position of the side portions is regulated independently of or decoupled from vertical and transverse guidance of the combine harvester is essential. No active transverse guidance of the attachment by the combine harvester is required. The vertical guidance of the attachment by the combine harvester has no influence on the positioning of the side portions. Each side portion can react to changes in the ground contour, wherein the positioning of the side portions takes place independently of the vertical and transverse guidance of the attachment as a whole. As a result, optimized adaptation to the existing ground contour can be achieved.

In particular, the side portions may be controlled or regulated taking into account a selectable operating mode for the ground guidance of the attachment, wherein the operating modes may be selected from the group consisting of “cutting height regulation”, “ground pressure regulation” and “cutting height preselection”. In this case, one of the operating modes can be selected by means of an operator terminal or some other input/output unit connected to the control apparatus. Thus, when “cutting height regulation” is the operating mode for ground guidance, a distance of the attachment relative to the ground can be defined by inputting at least one target value. When “ground pressure regulation” is the operating mode for ground guidance, the ground guidance takes place on the basis of a preset ground pressure by the attachment being placed on the ground with a weight proportion, defined as target value, of the total weight of the attachment. The ground pressure exerted on the ground is set by the activation of the at least one hydraulic cylinder on the pick-up apparatus by means of the control apparatus. When “cutting height preselection” is the operating mode for ground guidance, an inclination angle of the pick-up apparatus with respect to the longitudinal axis of the combine harvester is set at a defined target value.

Preferably, the positioning of the side portions independently of one another may be carried out by the respective actuator. The actuator may be embodied as a linear drive, in particular as a hydraulic cylinder. Preferably, the hydraulic cylinder is embodied as a double acting hydraulic cylinder. The respective actuator connects frame elements of the side portions and of the central portion together such that the respective side portion can be pivoted in a vertical direction about the frame joint relative to the central portion.

In particular, measurement signals from in each case at least two sensors arranged in a manner spaced apart from one another on the respective side portion and the central portion may be received and evaluated by the control apparatus, said signals to being used to determine a respective distance of the side portions and of the central portion from the ground. In particular, in each case one sensor of the respective side portion and of the central portion are arranged next to the pivot axis. At least one further sensor is arranged distally to the central portion in the region of the outer ends of the side portions.

In this case, the positioning of the respective side portions can be carried out independently of one another by the respective actuator depending on a sensor-determined distance difference of the respective side portion from the ground.

Preferably, in the “cutting height regulation” operating mode, the position of the respective side portion relative to the central portion may be regulated depending on a distance difference between a distance from the ground detected at the outer end of the side portion and a distance from the ground detected in the region of the pivot axis, by the actuator being activated until the distance difference is zero. The actuator is activated by the control apparatus to pivot the respective side portion until the distance difference between the distance from the ground detected at the outer end of the side portion and the distance from the ground detected in the region of the pivot axis is zero.

As a further preference, in the “ground pressure regulation” operating mode, the attachment is placed on the ground with a preset weight proportion of the total weight as target value, which is set by pressurization of the at least one hydraulic cylinder, wherein, to regulate the positioning of the respective side portion, the actuator may be activated depending on the target value and the part weight of the respective side portion such that the respective side portion is placed on the ground with its corresponding part weight proportion. The preset weight proportion with which the attachment is placed on the ground results from the pressure in the at least one hydraulic cylinder. The positioning of the side portions can, when the actuators are embodied as hydraulic cylinders, take place on the basis of the pressure in the respective hydraulic cylinder between the central portion and the respective side portion. The control apparatus may regulate the pressure in the respective hydraulic cylinder on the basis of the part weight proportion with which the respective side portion is intended to be placed on the ground.

As a further preference, in the “cutting height preselection” operating mode, an angle between the pick-up apparatus and the combine harvester is preset to define a cutting height target value, wherein, to position the respective side portion, it is detected whether at least one of the sensors of the respective side portion exhibits or detects contact with the ground with the set cutting height target value. As a result, different operating situations can be sensed in which the attachment can be operated. Thus, in one operating situation in the “cutting height preselection” operating mode, the attachment can be raised by the pick-up apparatus to such an extent that none of the sensors is in contact with the ground. This could be the case for example for high cutting. In an alternative operating situation in the “cutting height preselection” operating mode, the cutting height target value is selected such that the attachment is located close enough to the ground that at least one sensor exhibits or detects ground contact.

In this case, upon detection that none of the sensors is in contact with the ground, the respective side portion is transferred, by activation of the respective actuator, into a central position in which the respective side portion is positioned so as to be substantially aligned with the central portion.

By contrast, upon detection that at least one of the sensors exhibits contact with the ground, the positioning of the respective side portion may be carried out in accordance with the “cutting height regulation” operating mode. As a result, a collision of the respective side portion with the ground in the “cutting height preselection” operating mode can be avoided.

In particular, during operation without selection of an operating mode, the positioning of the respective side portion may be carried out in accordance with the “cutting height preselection” operating mode. During operation without selection of an operating mode, the current travel speed of the combine harvester or manual raising or lowering of the attachment are monitored. If the travel speed of the combine harvester exceeds a threshold value, for example 2 km/h or if the attachment is manually raised or lowered, the positioning of the side portions is activated analogously to the “cutting height preselection” operating mode in order to ensure that the side portions are moved relative to the central portion only when no people are located in the region of the side portions.

Preferably, to determine the position of each respective side portion relative to the central portion, a difference between a distance from the ground detected by at least one sensor at the outer end of the side portion and a distance from the ground detected by at least one sensor in the region of the pivot axis may be determined.

To this end, in the region of the pivot axis, to determine the distance from the ground, measurement signals from in each case one sensor arranged next to the pivot axis on the middle portion and on the side portion may be evaluated.

According to a teaching, which has independent significance, a self-propelled combine harvester having an attachment, in particular an attachment in the form of a draper header or draper, for carrying out the method is disclosed. Reference may be made to all statements in relation to the method according to the proposal that are suitable for explaining the work machine.

In particular, to detect the distance from the ground, sensors embodied as sensor arms may be arranged on the underside of the attachment. The sensor arms are preferably arranged at the smallest possible distance from the cutter bar in order to be able to detect changes in the ground contour early. In this case, in each case one sensor arm of the respective side portion and of the central portion may be arranged next to the pivot axis. In particular, at least one further sensor arm may be arranged distally to the central portion in the region of the outer ends of the side portions. Particularly preferably, two sensor arms are arranged at a distance from one another at the outer ends of the side portions, the distance between these sensor arms being smaller than the distance from the sensor arm of the side portion that is arranged next to the pivot axis.

Alternatively, support arms that are pivotable about an axis extending in the transverse direction and carry a cutter bar may be arranged on the central portion and the side portions, wherein, to sense a vertical deflection of the support arms of the central portion and of the side portions, in each case two sensors are provided, wherein the two sensors of the central portion are each embodied as a measuring shaft connected for conjoint rotation to at least one of the support arms of the central portion and the two sensors of the respective side portion are each embodied as a measuring shaft connected for conjoint rotation to at least two support arms of the respective side portion, and a potentiometer assigned to the respective measuring shaft. According to this configuration, support arm combinations are formed, which are each connected together by a measuring shaft and jointly generate a signal by means of a potentiometer. As a result, for ground guidance regulation, the control apparatus receives exactly as many signals as are necessary in order to be able to determine the positions of the side portions and of the central portion of the three-part attachment. Each portion supplies a respective left-hand and right-hand signal for the regulation in that in each case two measuring shafts are provided per side portion and central portion, with a total of six measuring shafts.

The measuring shafts may, in a specific manner of operation of the draper header, in which the cutter bar rests on the ground across the entire width of the draper header, sense the position in which the respective support arm that is pivotable about the axis extending transversely to the direction of travel is located relative to the frame of the central portion and of the side portions.

### BRIEF DESCRIPTION OF THE DRAWINGS

The present invention is explained in more detail in the following text on the basis of an exemplary embodiment illustrated in the drawings.

In the drawings:

FIG. 1 schematically shows, by way of example, a partial view of a combine harvester having an attachment arranged on it;

FIG. 2 schematically shows, by way of example, a partial view of an attachment embodied as a draper header; and

FIG. 3 shows a schematic and highly simplified illustration of the segmented attachment embodied as a draper header according to FIG. 2.

It should be understood that the drawings are not necessarily to scale. In certain instances, details that are not necessary to the understanding of the invention or render other details difficult to perceive may have been omitted. It should be understood, of course, that the invention is not necessarily limited to the particular embodiments illustrated herein.

### DETAILED DESCRIPTION

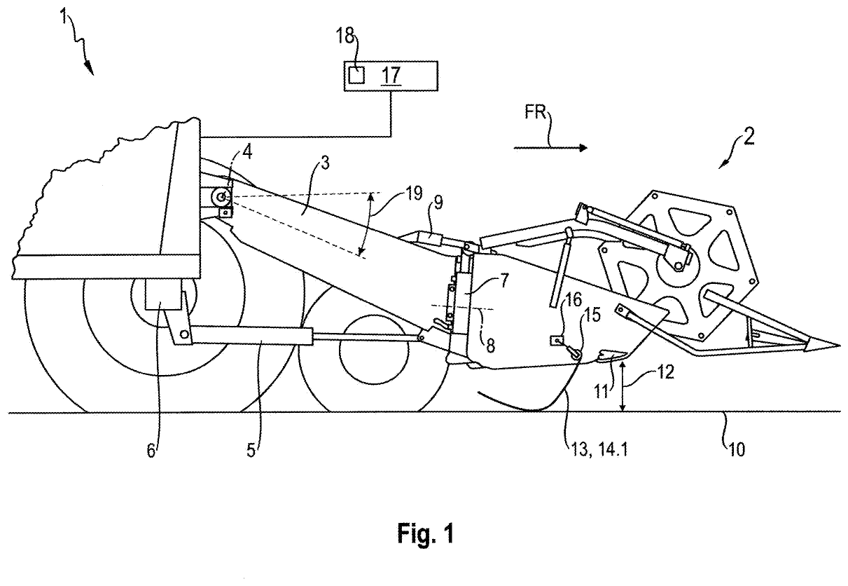

FIG. 1 schematically illustrates, by way of example, a partial view of a combine harvester 1 having an attachment 2 arranged on it. The attachment 2 is arranged on a pick-up apparatus 3. The pick-up apparatus 3 is pivotable about a pivot axis 4 vertically with respect to the direction of travel FR. The pick-up apparatus 3 is pivotable about the pivot axis 4 extending transversely to the direction of travel FR by at least one hydraulic cylinder 5, which is articulated to a bracket 6 of the combine harvester 1 at one end and to the pick-up apparatus 3 at its end on the piston-rod side.

By means of two lifting cylinders 7, of which only one is visible in FIG. 1, transverse adaptation of the attachment 2 to the current ground level is regulated, wherein, in the present exemplary embodiment, the lifting cylinder 7 can pivot the attachment 2 in a manner known per se about a virtual pendulum axis 8 directed in the direction of travel FR. A hydraulic cylinder 9 arranged on the top side of the pick-up apparatus 3 makes it possible to set a cutting angle that is enclosed by the attachment 2 and the ground 10.

The attachment 2 comprises a cutter bar 11, which is guided at a settable distance 12 from the ground 10. The distance 12 is set by the hydraulic cylinder 5. In order to monitor the maintenance of the distance 12 from the ground, a plurality of sensors 13 are arranged on the underside of the attachment 2. In the illustrated exemplary embodiment, the sensors 13 are embodied as a plurality of sensor arms 14.1 to 14.8, which are each pivotable about a shaft 15 extending transversely to the direction of travel FR. The pivoting movement of the respective sensor arm 14.1 to 14.8 is determined by means in each case of a potentiometer 16, which is coupled to the respective shaft 15. To activate the combine harvester 1 and its working units, which include, inter alia, the attachment 2 and the pick-up apparatus 3, a control apparatus 17 is provided.

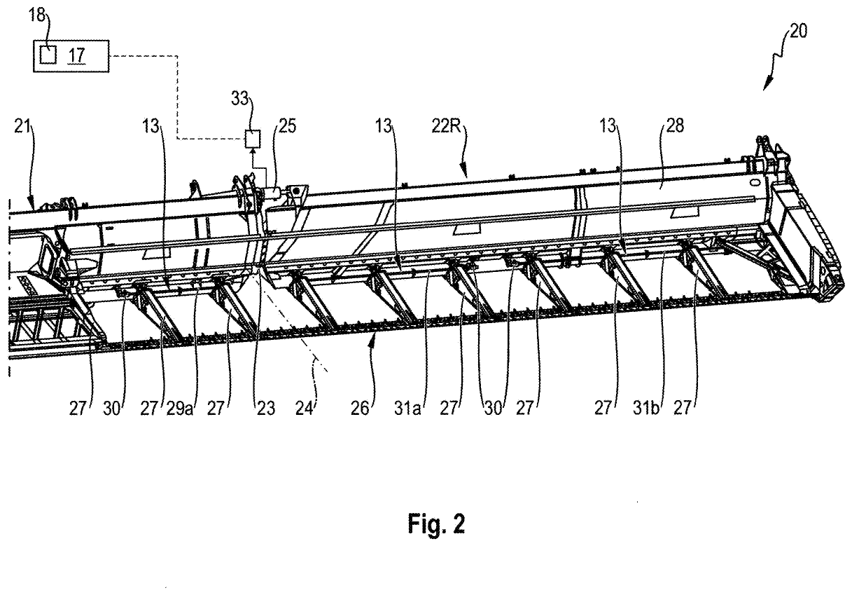

FIG. 2 schematically shows, by way of example, a partial view of an attachment 2 embodied as a draper header 20. The construction of the attachment 2 embodied as a draper header 20 is mirror-symmetric, and so the following statements apply correspondingly to the non-illustrated half of the draper header 20. The draper header 20 comprises a central portion 21, only half of which is illustrated in FIG. 2, and at least two side portions 22L, 22R. Only one of the side portions 22L, 22R is shown in FIG. 2. The draper header 20 is arranged on the pick-up apparatus 3 in the region of the central portion 21. To convey the picked-up harvested material, conveyor belts—not illustrated—are provided, which, in a known manner, convey the harvested material sideways from the side portions 22L, 22R to the central portion 21. The respective side portions 22L, 22R are each connected to the central portion 21 by a frame joint 23 so as to be pivotable about a pivot axis 24 that is oriented parallel to the direction of travel FR and extends substantially horizontally. The respective side portion 22L, 22R is pivotable in a vertical direction about the pivot axis 24 relative to the central portion 21 by means of an actuator 25. Assigned to the actuator 25 embodied here and preferably as a hydraulic cylinder is a pressure sensor 33, which senses the pressurization of the actuator 25 in order to activate the latter by way of the control apparatus 17. Assigned to the respective pivot axis 24 is a sensor device, embodied in particular as a potentiometer, which serves to determine the position of the respective side portion 22L, 22R relative to the central portion 21.

Arranged in the front region of the attachment 2 embodied in the form of a draper header 20 is a flexible cutter bar 26, which extends substantially across the entire width of the draper header 20. A plurality of support arms 27, which are arranged in a manner distributed across the width of the draper header 20 and are arranged with one end on the frame 28, segmented into the central portion 21 and the at least two side portions 22L, 22R, of the draper header 20 so as to be pivotable about an axis extending transversely to the direction of travel FR, carry the cutter bar 26. As a result of the individual pivotability of the support arms 27, the flexible cutter bar 26 can carry out a compensating movement in a vertical direction in order to react to a change in the ground contour. In the process, the cutter bar 26 can experience a substantially undulating deflection.

The support arms 27, arranged on both sides next to the pick-up apparatus 3, of the central portion 21 are each connected together by a measuring shaft 29a, 29b, which is connected for conjoint rotation to the respective support arms 27. Arranged on the respective measuring shaft 29a, 29b is at least one potentiometer 30, which senses the vertical deflection of the support arms 27 connected together by the measuring shaft 29a, 29b. The support arms 27 of the central portion 22 are likewise connected together by measuring shafts 31a, 31b that are connected for conjoint rotation to the respective support arm 27. Here and preferably, at least two measuring shafts 31a, 31b and 32a, 32b, respectively, are provided on each side portion 22, of which the measuring shaft 31a or 32a, starting from the central portion 21, couples two or more support arms 27 together for measurement purposes. Starting from the outer end region of the side portion 22L, 22R, the measuring shaft 31b or 32b couples two or more support arms 27 together for measurement purposes.

At least one potentiometer 30 is likewise arranged on the respective measuring shaft 31a, 31b, 32a, 32b. The measuring shafts 29a, 29b, 31a, 31b, 32a, 32b and the associated potentiometers 30 likewise form sensors 13, with which a vertical distance 12 of the draper header 20 from the ground 10 is determined in a manner known per se. The measuring shafts 29a, 29b, 31a, 31b, 32a, 32b, in a specific manner of operation of the draper header 20, in which the cutter bar 26 rests on the ground 10 across the entire width of the draper header 20, sense the position in which the respective support arm 27 that is pivotable about the axis extending transversely to the direction of travel FR is located relative to the frame 28 of the central portion 21 and of the side portions 22L, 22R. The segmented frame 28 is in this case guided by the raising and lowering of the pick-up apparatus 3 in a desired position with respect to the support arms 27, while the cutter bar 26 follows the ground contour. During operation in this specific manner of operation of the draper header 20, the distance of the segmented frame 28 from the ground 10 is determined for each frame segment by means of the measuring shafts 29a, 29b, 31a, 31b, 32a, 32b.

As a result of the support arms 27 being connected for conjoint rotation to the respective measuring shaft 29a, 29b, 31a, 31b, 32a, 32b, the deflection of the support arms 27 by a deflection in the vertical direction on account of the ground contour is sensed. The signals from the measuring shafts 29a, 29b, 31a, 31b, 32a, 32b are evaluated, analogously to the signals from the sensors 13 embodied as sensor arms 14.1 to 14.8, by the control apparatus 17 of the combine harvester 1.

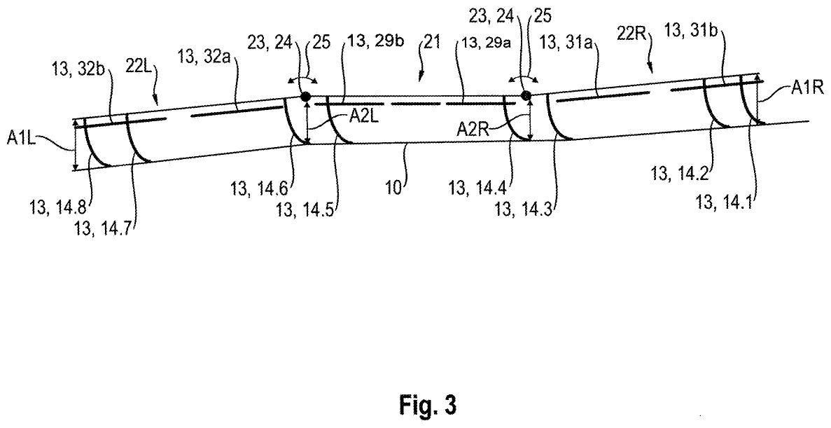

The illustration in FIG. 3 shows a schematic and highly simplified illustration of the segmented attachment 20 embodied as a draper header 3 according to FIG. 2. For reasons of simplification, the illustration simultaneously shows the arrangement of the sensors 13, which may either be sensor arms 14.1 to 14.8 or measuring shafts 29a, 29b, 31a, 31b, 32a, 32b. The basic procedure with which, for the ground guidance of the attachment 2, the positioning of the side portions 22L, 22R relative to the central portion 21 is controlled or regulated independently of vertical and transverse guidance, activated by the combine harvester 1, of the attachment 2 does not differ in this case. Merely the type and/or number of the sensors 13 may vary.

The actuators 25 which pivot the respective side portion 22L, 22R about the pivot axis 24 relative to the central portion 21 are symbolically indicated by arrows. This applies in a corresponding manner for the symbolic illustration of the frame joints 23 and the pivot axes 24 between the central portion 21 and the side portions 22.

The side portions 22L, 22R are controlled or regulated taking into account a selectable operating mode for ground guidance of the attachment 2. The operating modes can be selected from the group consisting of “cutting height regulation”, “ground pressure regulation” and “cutting height preselection”. In this case, one of the operating modes can be selected by means of an operator terminal or some other input/output unit 18 connected to the control apparatus 17 of the combine harvester 1.

When cutting height regulation is the operating mode for ground guidance, the distance 12 of the attachment 3 relative to the ground 10 is defined by inputting at least one target value. When ground pressure regulation is the operating mode for ground guidance, the ground guidance takes place on the basis of a preset ground pressure by the attachment 3 being placed on the ground 10 with a weight proportion, defined as target value, of the total weight of the attachment 3. The ground pressure exerted on the ground 10 is set by the activation of the at least one hydraulic cylinder 5 on the pick-up apparatus 3. When cutting height preselection is the operating mode for ground guidance, an inclination angle 19 about which the pick-up apparatus 3 has been pivoted about the horizontally extending pivot axis 4 relative to the combine harvester 1 is set at a defined target value for the position of the pick-up apparatus 3 relative to the ground 10.

In the “cutting height regulation” operating mode, the position of the respective side portion 22R, 22L relative to the central portion 21 is regulated depending on a distance difference ΔT_{R} or ΔT_{L}, respectively, between a distance A1R, A1L from the ground 10 detected at the outer end of the respective side portion 22R, 22L and a distance A2R, A2L from the ground 10 detected in the region of the pivot axis 24, by the actuator 25 being activated until the respective distance difference ΔT_{R} or ΔT_{L} of the side portions 22R, 22L is zero.

To this end, the distance difference ΔT_{R} or the distance difference ΔT_{L} of the respective side portion 22R, 22L is determined as follows in the case of sensors 13 embodied as sensor arms 14.1 to 14.8:

ΔT_{R}=min(14.1, 14.2)−min(14.3, 14.4)

and

ΔT_{L}=min(14.7, 14.8)−min(14.5, 14.6)

In this case, the minimum value sensed by the sensor arms 14.1, 14.2 and 14.7, 14.8, respectively, and 14.3, 14.4 and 14.5, 14.6, respectively, is used for a distance A1R, A1L or A2R, A2L, respectively. The aim of the regulation is that the distance difference ΔT_{R} or ΔT_{L}, respectively, of the side portions 22R, 22L is zero in each case.

When the sensors 13 are measuring shafts 29a, 29b, 31a, 31b, 32a, 32b, distance differences ΔF_{R} and ΔF_{L} that are different than in the use of sensor arms 14.1 to 14.8, which, on account of their specific arrangement, measure in a pointwise manner, are determined by evaluation of distances of a respective side portion 22R, 22L that are sensed at a plurality of points of the respective side portions 22R, 22L. The measuring shafts 31b, 32b sense the distance A1R, A1L at the outer ends of the side portions 22R, 22L, while the measuring shafts 31a, 32a sense a value for the distance A2R, A2L in the region of the pivot axis 24. The measuring shafts 29a, 29a at the central portion 21 likewise sense a value for the distance A2R, A2L.

For example, the determination of the distance difference ΔF_{R} is illustrated at the side portion 22R. The following statements apply correspondingly to the side portion 22L.

A distance difference ΔF_{R,MA}, is from the determined distance values of the measurement shafts 31b and 31a of the side portion 22R, a distance difference ΔF_{R,IM} is from the determined distance values of the measuring shaft 31a at the side portion 22R and the measuring shaft 29a at the central portion 21, and a distance difference ΔF_{R,IA} is from the determined distance values of the measuring shaft 29a at the central portion 21 and the measuring shaft 31b at the side portion 22R. Just like when the regulation is carried out with the sensor arms 14.1 to 14.8, the objective is for the distance difference ΔF_{R} or ΔF_{L} to be regulated in each case to a value of zero as a result of the actuators 25 being activated by the control apparatus 17.

The distance difference ΔF_{R} is in this case determined as follows:

$$Δ {F}_{R} = \{ \begin{matrix}Δ {F}_{R , IA} for \vert Δ {F}_{R , MA} \vert > \vert Δ {F}_{R , IM} \vert \\ - Δ {F}_{R , IA} for \vert Δ {F}_{R , MA} \vert \leq \vert Δ {F}_{R , IM} \vert\end{matrix} .$$

In the “ground pressure regulation” operating mode, the attachment 2 is placed on the ground 10 with a preset weight proportion of the total weight as a target value. The weight proportion is set by the pressurization of the at least one hydraulic cylinder 5. To regulate the positioning of the respective side portion 22R, 22L, the actuator 25 is activated depending on the target value and the part weight of the respective side portion 22R, 22L such that the respective side portion 22R, 22L is placed on the ground 10 with its corresponding part weight proportion. The mutually independent positioning of the side portions can 22R, 22L, when the actuators 25 are embodied as hydraulic cylinders, take place on the basis of the pressure in the respective hydraulic cylinder between the central portion 21 and the respective side portion 22R, 22L. The control apparatus 17 can regulate the pressure in the respective hydraulic cylinder on the basis of the part weight proportion of the respective side portion 22R, 22L, with which the respective side portion 22R, 22L is intended to be placed on the ground 10.

In the “cutting height preselection” operating mode, the inclination angle 19 between the pick-up apparatus 3 and the combine harvester 1 is preset to define a cutting height target value, wherein it is provided that, to position the respective side portion 22R, 22L, it is detected whether at least one of the sensors 13 of the respective side portion 22L, 22R exhibits contact with the ground 10 with the set cutting height target value. As a result, different operating situations can be sensed in which the attachment 2 can be operated. Thus, in one operating situation in the “cutting height preselection” operating mode, the attachment 2 can be raised by the pick-up apparatus 3 to such an extent that none of the sensors 13 is in contact with the ground, or, when the sensors 13 are embodied as measuring shafts 29a, 29b, 31a, 31b, 32a, 32b, none of the sensors 13 detects contact with the ground. This could be the case for example for high cutting. In an alternative operating situation in the “cutting height preselection” operating mode, the cutting height target value is selected such that the attachment 2 is located close enough to the ground 10 that at least one sensor 13 exhibits or detects ground contact.

In this case, upon detection that none of the sensors 13 is in contact with the ground, the respective side portion 22R, 22L is transferred, by activation of the respective actuator 25, into a central position in which the respective side portion 22R, 22L is positioned so as to be substantially aligned with the central portion 21. For activation, the signals from the sensor device assigned to the respective pivot axis 24 are used.

By contrast, upon detection that at least one of the sensors 13 exhibits or detects contact with the ground, the positioning of the respective side portion 22R, 22L is carried out in accordance with the “cutting height regulation” operating mode. As a result, a collision of the respective side portion 22R, 22L with the ground 10 in the “cutting height preselection” operating mode can be avoided.

In particular, during operation without selection of an operating mode, the positioning of the respective side portion 22R, 22L can be carried out in accordance with the “cutting height preselection” operating mode. During operation without selection of an operating mode, the current travel speed of the combine harvester 1 or manual raising or lowering of the attachment 2 are monitored. If the travel speed of the combine harvester 1 exceeds a threshold value, for example 2 km/h or if the attachment 2 is manually raised, the positioning of the side portions 22R, 22L is activated analogously to the “cutting height preselection” operating mode in order to ensure that the side portions 22R, 22L are moved relative to the central portion 21 only when no people are located in the region of the side portions 22R, 22L.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that references to relative positions (e.g., “top” and “bottom”) in this description are merely used to identify various elements as are oriented in the Figures. It should be recognized that the orientation of particular components may vary greatly depending on the application in which they are used.

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It is also important to note that the construction and arrangement of the battery or electrodes or separator as shown and described in the various examples of embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the interfaces may be reversed or otherwise varied, the length or width of the structures and/or members or connector or other elements of the system may be varied, the nature or number of adjustment positions provided between the elements may be varied (e.g. by variations in the number of engagement slots or size of the engagement slots or type of engagement). The order or sequence of any process or method steps may be varied or re-sequenced according to alternative embodiments. Other substitutions, modifications, changes and omissions may be made in the design, operating conditions and arrangement of the various examples of embodiments without departing from the spirit or scope of the present inventions.

List of reference signs

| | |
|---|---|
| 1 | Combine harvester |
| 2 | Attachment |
| 3 | Pick-up apparatus |
| 4 | Pivot axis |
| 5 | Hydraulic cylinder |
| 6 | Bracket |
| 7 | Lifting cylinder |
| 8 | Pendulum axis |
| 9 | Hydraulic cylinder |
| 10 | Ground |
| 11 | Cutter bar |
| 12 | Distance |
| 13 | Sensor |
| 14.1 | Sensor arm |
| 14.2 | Sensor arm |
| 14.3 | Sensor arm |
| 14.4 | Sensor arm |
| 14.5 | Sensor arm |
| 14.6 | Sensor arm |
| 14.7 | Sensor arm |
| 14.8 | Sensor arm |
| 15 | Shaft |
| 16 | Potentiometer |
| 17 | Control apparatus |
| 18 | Input/output unit |
| 19 | Inclination angle |
| 20 | Draper header |
| 21 | Central portion |
| 22R | Side portion |
| 22L | Side portion |
| 23 | Frame joint |
| 24 | Pivot axis |
| 25 | Actuator |
| 26 | Cutter bar |
| 27 | Support arm |
| 28 | Frame |
| 29a | Measuring shaft |
| 29b | Measuring shaft |
| 30 | Potentiometer |
| 31a | Measuring shaft |
| 31b | Measuring shaft |
| 32a | Measuring shaft |
| 32b | Measuring shaft |
| 33 | Pressure sensor |
| A1L | Distance |
| A1R | Distance |
| A2L | Distance |
| A2R | Distance |
| FR | Direction of travel |

What is claimed is:

1. A method for operating an attachment arranged on a pick-up apparatus of a self-propelled combine harvester, wherein the attachment comprises a central portion and two side portions which are each connected to the central portion by a frame joint so as to be pivotable about a pivot axis oriented in the direction of travel, wherein the respective side portion is pivotable about the pivot axis transversely to the direction of travel relative to the central portion by means of an actuator that is activated by a control apparatus, wherein a vertical distance of the attachment from the ground is adaptively set by at least one hydraulic cylinder on the pick-up apparatus, characterized in that, for the ground guidance of the attachment, the positioning of the side portions relative to the central portion is controlled or regulated independently of vertical and transverse guidance, activated by the combine harvester, of the attachment.

2. The method according to claim 1, characterized in that the side portions are controlled or regulated taking into account a selectable operating mode for the ground guidance of the attachment, wherein the operating modes are selected from the group consisting of “cutting height regulation”, “ground pressure regulation” and “cutting height preselection”.

3. The method according to claim 1, characterized in that the positioning of the side portions independently of one another is carried out by the respective actuator.

4. The method according to one of claim 1, characterized in that measurement signals from in each case at least two sensors arranged in a manner spaced apart from one another on the respective side portion and the central portion are received and evaluated by the control apparatus, said signals to being used to determine a respective distance of the side portions and of the central portion from the ground.

5. The method according to claim 1, characterized in that, in the “cutting height regulation” operating mode, the position of the respective side portion relative to the central portion is regulated depending on a distance difference between a distance from the ground detected at the outer end of the side portion and a distance from the ground detected in the region of the pivot axis, by the actuator being activated until the distance difference is zero.

6. The method according to claim 2, characterized in that, in the “ground pressure regulation” operating mode, the attachment is placed on the ground with a preset weight proportion of the total weight as target value, which is set by pressurization of the at least one hydraulic cylinder, and in that, to regulate the positioning of the respective side portion, the actuator is activated depending on the target value and the part weight of the respective side portion such that the respective side portion is placed on the ground with its corresponding part weight proportion.

7. The method according to claim 2, characterized in that, in the “cutting height preselection” operating mode, an inclination angle between the pick-up apparatus and the combine harvester is preset to define a cutting height target value, and in that, to position the respective side portion, it is detected whether at least one of the sensors of the respective side portion exhibits or detects contact with the ground with the set cutting height target value.

8. The method according to claim 7, characterized in that upon detection that none of the sensors is in contact with the ground, the respective side portion is transferred, by activation of the respective actuator, into a central position in which the respective side portion is positioned so as to be substantially aligned with the central portion.

9. The method according to claim 7, characterized in that upon detection that at least one of the sensors exhibits or detects contact with the ground, the positioning of the respective side portion is carried out in accordance with the “cutting height regulation” operating mode.

10. The method according to claim 2, characterized in that, during operation without selection of an operating mode, the positioning of the respective side portion is carried out in accordance with the “cutting height preselection” operating mode.

11. The method according to claim 1, characterized in that, to determine the position of each respective side portion relative to the central portion, the difference between a distance from the ground detected by at least one sensor at the outer end of the side portion and a distance from the ground detected by at least one sensor in the region of the pivot axis is determined.

12. The method according to claim 11, characterized in that, in the region of the pivot axis, to determine the distance from the ground, measurement signals from in each case one sensor arranged next to the pivot axis on the middle portion and on the side portion are evaluated.

13. A self-propelled combine harvester having a segmented attachment, in particular a draper header, for carrying out a method according to claim 1.

14. The self-propelled combine harvester according to claim 13, characterized in that, to detect a distance from the ground, sensors embodied as sensor arms (are arranged on the underside of the attachment.

15. The self-propelled combine harvester according to claim 13, characterized in that support arms that are pivotable about an axis extending in the transverse direction and carry a cutter bar are arranged on the central portion and the side portions, wherein, to sense a vertical deflection of the support arms of the central portion and of the side portions, in each case two sensors are provided, wherein the two sensors of the central portion are each embodied as a measuring shaft connected for conjoint rotation to at least one of the support arms of the central portion and the two sensors of the side portions are each embodied as a measuring shaft for conjoint rotation to at least two support arms of the respective side portion, and a potentiometer assigned to the respective measuring shaft.
